(19) United States
(12) Patent Application Publication
(10) Pub. No.: US 2018/0170209 A1
(43) Pub. Date: Jun. 21, 2018

(54) TRACTION BATTERY PACK SERVICE PANEL

(71) Applicant: Ford Global Technologies, LLC, Dearborn, MI (US)

(72) Inventors: Patrick Daniel Maguire, Ann Arbor, MI (US); Nelson Alexander Brock, Detroit, MI (US)

(21) Appl. No.: 15/381,586

(22) Filed: Dec. 16, 2016

(51) Int. Cl. B60L 11/18; H01M 2/10

(52) U.S. Cl. CPC B60L 11/1879; Y10S 903/952; H01M 2220/20; H01M 2/1077

(57) ABSTRACT

An exemplary battery assembly includes an enclosure defining an interior, and a service panel that covers an opening to the interior. The service panel is held relative to the enclosure by a clip. An exemplary method includes covering an opening in an enclosure with a service panel that is clipped to the enclosure. The opening permits access to a serviceable part housed inside of the enclosure assembly prior to the covering.

### TECHNICAL FIELD

This disclosure relates to a service panel, and more particularly, but not exclusively, to a service panel that covers a service opening in an enclosure of a traction battery pack.

### BACKGROUND

Electrified vehicles differ from conventional motor vehicles because electrified vehicles are selectively driven using one or more electric machines powered by a traction battery pack. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery pack can be used to selectively power the electric machines and other electrical loads of the electrified vehicle. The traction battery can be mounted external to a vehicle body structure. The traction battery pack includes multiple interconnected battery cells and other components housed within an enclosure. The battery cells store energy for powering the electrical loads.

Traditionally, enclosures have been a metal or metal alloy. Some enclosures are now polymer-based. From time to time, servicing components through an opening within the enclosure may be required.

### SUMMARY

A battery assembly according to an exemplary aspect of the present disclosure includes, among other things, an enclosure defining an interior, and a service panel that covers an opening to the interior. The service panel is held relative to the enclosure by a clip.

In a further non-limiting embodiment of the foregoing assembly, the service panel and the enclosure are both polymer based.

In a further non-limiting embodiment of any of the foregoing assemblies, the clip is integrally formed with the service panel.

In a further non-limiting embodiment of any of the foregoing assemblies, the at least one clip includes an overhang surface that contacts a surface of the enclosure facing toward the interior to hold a portion of the enclosure between a body of the service panel and the overhang surface.

In a further non-limiting embodiment of any of the foregoing assemblies, the surface is provided a stepped area in a wall of the enclosure that is thinned relative to other areas of the wall.

In a further non-limiting embodiment of any of the foregoing assemblies, the clip is integrally formed with the enclosure and include an overhang surface that contacts a surface of the service panel facing away from the interior to hold a portion of the service panel between enclosure and the overhang surface.

In a further non-limiting embodiment of any of the foregoing assemblies, the clip is configured to move from a more flexed position to a less flexed position to hold the service panel relative to the enclosure.

In a further non-limiting embodiment of any of the foregoing assemblies, the clip includes a panel clip integrally formed with the service panel and an enclosure clip integrally formed with the enclosure. The panel clip provides an overhang surface that contacts a surface of the enclosure facing toward the interior to hold a portion of the enclosure between a portion of the service panel and the overhang surface. The enclosure clip provides another overhang surface that contacts a surface of the service panel facing away from the interior to hold a portion of the service panel between enclosure and the overhang surface.

In a further non-limiting embodiment of any of the foregoing assemblies, the assembly includes a flange of the service panel. The flange is biased against an outwardly facing surface of the enclosure when the service panel is held relative to the enclosure such that the flange seals an interface between the service panel and the enclosure.

In a further non-limiting embodiment of any of the foregoing assemblies, the flange circumscribes a perimeter of a body of the service panel.

In a further non-limiting embodiment of any of the foregoing assemblies, the assembly includes a compressible seal member that seals an interface between the service panel and the enclosure.

In a further non-limiting embodiment of any of the foregoing assemblies, the assembly includes a ductile portion of the service panel that is removable to access the clip.

In a further non-limiting embodiment of any of the foregoing assemblies, the opening is a service opening, and the interior accommodates a serviceable part.

In a further non-limiting embodiment of any of the foregoing assemblies, the enclosure and the service panel are portions of a traction battery pack of an electrified vehicle.

A method according to an exemplary aspect of the present disclosure includes, among other things, covering an opening in an enclosure with a service panel that is clipped to the enclosure. The opening permits access to a serviceable part housed inside of the enclosure assembly prior to the covering.

In a further non-limiting embodiment of the foregoing method, a clip that clips the service panel to the opening is integrally formed with the service panel or the enclosure.

In a further non-limiting embodiment of any of the foregoing methods, the method includes compressing a seal member between the service panel and the enclosure to seal an interface between the service panel and the enclosure.

In a further non-limiting embodiment of any of the foregoing methods, the method includes biasing a flange of the service panel against an outwardly facing surface of the enclosure to seal an interface between the service panel and the enclosure.

In a further non-limiting embodiment of any of the foregoing methods, the flange flexes during the biasing.

In a further non-limiting embodiment of any of the foregoing methods, the method includes, prior to the covering, establishing the opening in the enclosure by removing a cover that is integrally formed with the enclosure.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of an example powertrain for an electrified vehicle.

FIG. 2 illustrates a side view of a traction battery pack from the powertrain of FIG. 1 secured adjacent a vehicle frame.

FIG. 3 illustrates a section view at Line 3-3 in FIG. 2 through a service lid integrally formed with an enclosure of the traction battery pack

FIG. 4 illustrates a partially expanded perspective view of the traction battery pack of FIG. 2 with the service lid removed to provide a service opening.

FIG. 5 illustrates a perspective view of the traction battery pack of FIG. 3 after a service panel has been clipped to the enclosure to cover the service opening.

FIG. 6 illustrates a section view at Line 6-6 in FIG. 4 through the service panel clipped to the enclosure.

FIG. 7 illustrates a close-up view of Area 7 in FIG. 6.

FIG. 8 illustrates a section view of a service panel according to another exemplary embodiment of this disclosure.

FIG. 9 illustrates a section view of a service panel according to yet another exemplary aspect of the present disclosure.

FIG. 10 illustrates a section and perspective view of the service panel of FIG. 9.

FIG. 11 illustrates a section and perspective view of a service panel according to yet another exemplary aspect of the present disclosure.

FIG. 12 illustrates a section view of a service panel according to yet another exemplary aspect of the present disclosure.

FIG. 13 illustrates a section view of a service panel according to yet another exemplary aspect of the present disclosure.

### DETAILED DESCRIPTION

This disclosure relates to a service panel that covers an opening of a traction battery pack enclosure. In some examples, the opening is a service opening established by removing a service lid integrally formed with the enclosure.

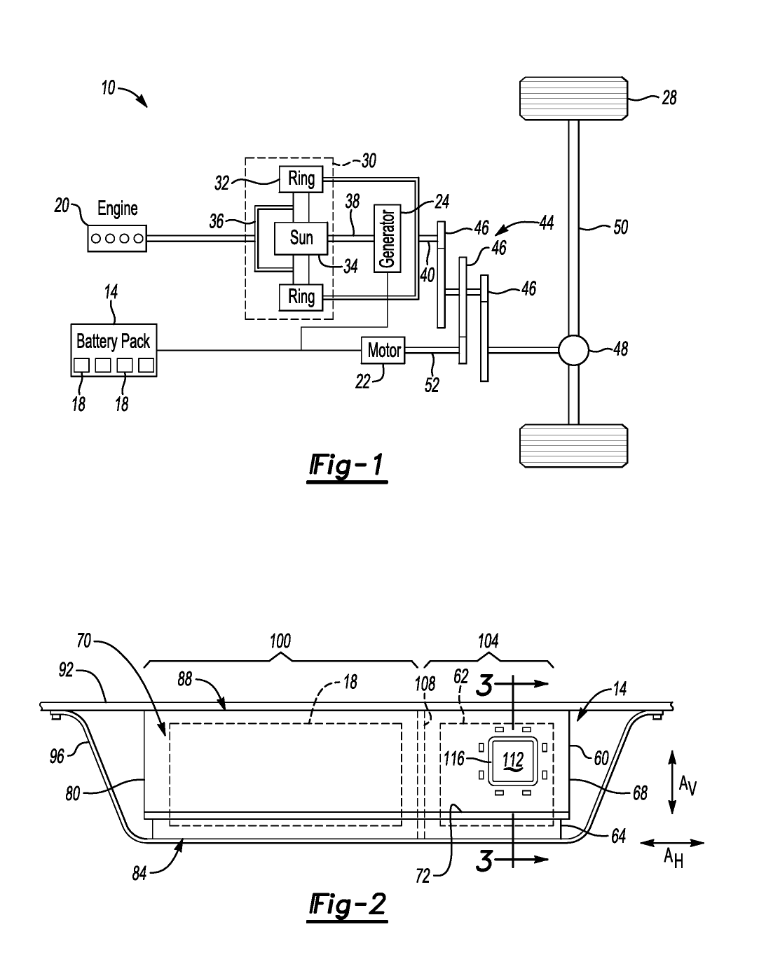

FIG. 1 schematically illustrates a powertrain 10 for an electrified vehicle. Although depicted as a hybrid electric vehicle (HEV), it should be understood that the concepts described herein are not limited to HEVs and could extend to any other type of electrified vehicle, including, but not limited to, plug-in hybrid electric vehicles (PHEVs), battery electric vehicles (BEVs), fuel cell vehicles, etc.

The powertrain 10 includes a traction battery pack 14 having a plurality of battery arrays 18, an internal combustion engine 20, a motor 22, and a generator 24. The motor 22 and the generator 24 are types of electric machines. The motor 22 and generator 24 may be separate or have the form of a combined motor-generator.

In this embodiment, the powertrain 10 is a power-split powertrain that employs a first drive system and a second drive system. The first and second drive systems generate torque to drive one or more sets of vehicle drive wheels 28. The first drive system includes a combination of the engine 20 and the generator 24. The second drive system includes at least the motor 22, the generator 24, and the traction battery pack 14. The motor 22 and the generator 24 are portions of an electric drive system of the powertrain 10.

The engine 20 and the generator 24 can be connected through a power transfer unit 30, such as a planetary gear set. Of course, other types of power transfer units, including other gear sets and transmissions, can be used to connect the engine 20 to the generator 24. In one non-limiting embodiment, the power transfer unit 30 is a planetary gear set that includes a ring gear 32, a sun gear 34, and a carrier assembly 36.

The generator 24 can be driven by the engine 20 through the power transfer unit 30 to convert kinetic energy to electrical energy. The generator 24 can alternatively function as a motor to convert electrical energy into kinetic energy, thereby outputting torque to a shaft 38 connected to the power transfer unit 30.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples.

The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 can be selectively employed to drive the vehicle drive wheels 28 by outputting torque to a shaft 52 that is also connected to the second power transfer unit 44. In this embodiment, the motor 22 and the generator 24 cooperate as part of a regenerative braking system in which both the motor 22 and the generator 24 can be employed as motors to output torque. For example, the motor 22 and the generator 24 can each output electrical power to recharge cells of the traction battery pack 14.

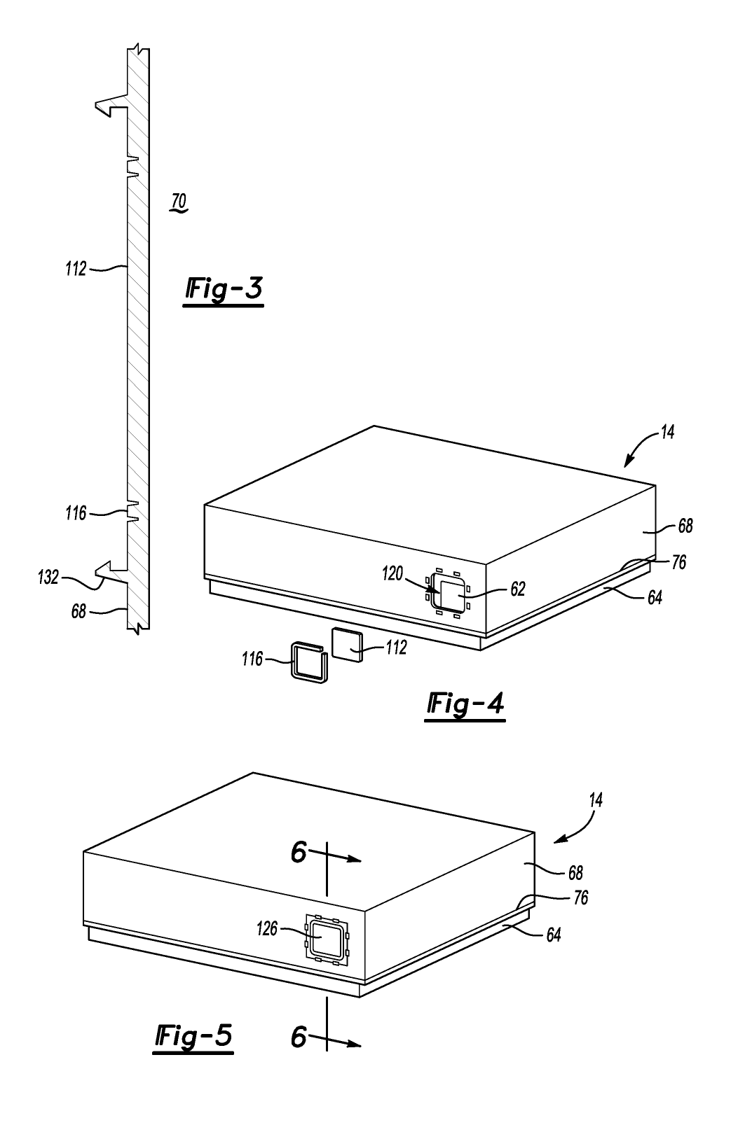

Referring now to FIGS. 2 to 4, the traction battery pack 14 includes an enclosure 60 that houses the plurality of battery arrays 18 and other components 62. The enclosure 60 generally includes a tray 64 and a cover 68. The battery arrays 18 and the other components 62 are held within an interior 70 provided between the tray 64 and the cover 68.

In an example non-limiting embodiment, the enclosure 60 is a polymer-based enclosure, such as a thermoplastic. The exemplary enclosure 60 could be, for example, a neat, or pure, thermoplastic. In other examples, the enclosure 60 could include other types of thermoplastics and thermosets with reinforcing fibers, such as glass or carbon, or other fillers, such as talc or glass beads.

The tray 64 is hermetically sealed to the cover 68 along an interface 72. Vibration welding, laser welding, infrared welding, adhesives, or other joining methods can be used to secure the tray 64 to the cover 68 and to provide the hermetic seal. The example interface 72 extends continuously about a perimeter of the traction battery pack 14.

The enclosure 60 has a plurality of horizontally facing sides 80 extending between a bottom vertically facing side 84 and a top vertically facing side 88. In this example, the tray 64 provides the bottom vertically facing side 84 and a portion of the horizontally facing sides 80, and the cover 68 provides the top vertically facing side 88 and another portion of the horizontally facing sides 80.

Vertical and horizontal, for purposes of this disclosure are with reference to ground or the horizon. Thus, vertical, in FIG. 2, extends along a vertical axis Av extending from the bottom vertically facing side 84 to the top vertically facing side 88. A horizontal axis AH extends in a direction perpendicular to the vertical axis Av.

The traction battery pack 14 is held against a vehicle frame 92 by at least one strap 96. The strap 96 extends along the bottom vertically facing side 84 of the enclosure 60. Opposing ends of the strap 96 are secured directly to the vehicle frame 92. Securing the strap 96 to the vehicle frame 92 pulls the traction battery pack 14 vertically upward relative to the vehicle frame 92, which can compress the traction battery pack 14 between the vehicle frame 92 and the strap 96.

Within the enclosure, the battery arrays 18 are housed within an array portion 100 and the other components 62 are housed within a serviceable portion 104. The array portion 100 could be separated from the serviceable portion 104 by a wall 108 internal to the enclosure 60. The wall 108 separates the interior 70 into two or more distinct sections.

The components 62 within the serviceable portion 104 could include one or more of the following components: a battery control module (BCM), a bussed electrical center (BEC), a control module, electronics, high voltage electrical cabling, a fuse, a battery cell (if the battery arrays 18 are serviceable), or any other component of the traction battery pack 14. The components 62 could instead, or additionally, include other components assisting with control and/or management of the traction battery pack 14.

In this example, the components 62 are serviceable components and the battery arrays 18 are non-serviceable components. In another example, the battery arrays 18 could be serviceable components.

Serviceable components, for purposes of this disclosure, can include any component that can be repaired, replaced, or evaluated to permit continued use of the traction battery pack 14 within the powertrain 10 (FIG. 1). As can be appreciated, repair, replacement, or evaluation can require access to the serviceable component within the enclosure 60. Access points can, undesirably, provide passages for contaminants to enter the interior 70 of the enclosure 60.

To provide access to the serviceable components, the enclosure 60 includes a service lid 112 that is integrally formed with the cover 68 of the enclosure 60. The service lid 112 includes a tear strip 116 circumferentially distributed about its perimeter.

When access to components within the interior 70 is required, the tear strip 116 is pulled, which separates the service lid 112 from the cover 68 to provide a service opening 120 within the cover 68. A technician can then access components 62 within the interior 70 through the service opening 120. Unless the tear strip 116 is pulled, the service lid 112 blocks contaminants from entering the interior 70 through the service opening 120. Since the service lid 112 is separated from the cover 68 when the tear strip 116 is removed, reusing the service lid 112 to cover the service opening 120 after servicing may not be possible.

In place of the service lid 112, and with reference to FIGS. 5 to 7, a service panel 126 is used to cover the service opening 120. After servicing, the service panel 126 takes the place of the service lid 112 and blocks contaminants from entering the interior 70 so that the traction battery pack 14 can be reused after servicing. That is, the traction battery pack 14 can be returned to service with the service panel 126 covering the service opening 120 rather than the service lid 112.

Since, in this example, the service panel 126 takes the place of the service lid 112 after servicing the traction battery pack 14. The service panel 126 can be considered an after-market component. In another example, the service lid 112 is not used and the traction battery pack 14 is introduced to market with the service panel 126. In still other examples, the service lid 112 is not used, and the service opening 130 is cut into the cover 68.

Although described as covering the service opening 120, the service panel 126 could instead be used to cover another type of opening in the enclosure 60. Further, although the service panel 126, and the remaining service panels of this disclosure, are described in connection with covering the service opening 120 in the cover 68 and in one of the horizontally facing sides 80, the service panels of this disclosure could be used to cover openings in another area of the enclosure, such as an opening in the bottom vertically facing side 84, the top vertically facing side 88, or an opening in the tray 64 and in one of the horizontally facing sides 80. The exemplary service panels of this disclosure could be also used to cover openings extending from the tray 64 to the cover 68, or from one of the sides to another of the sides, such as an opening extending from the bottom vertically facing side 84 to one of the horizontally facing sides 80.

The service panel 126, like the enclosure 60, is molded from a polymer based material. The material composition of the service panel 126 may differ from the material composition of the enclosure 60. For example, the service panel 126 could include a thermoplastic utilizing reinforcing fibers, such as glass or carbon, whereas the enclosure 60 is formed from a thermoplastic without reinforcing fibers.

The example service panel 126 is held relative to the cover 68 of the enclosure 60 with at least one panel clip 130 and at least one enclosure clip 132. In another example, the service panel 126 is held relative to the cover 68 of the enclosure 60 with at least one panel clip 130 or at least one enclosure clip 132.

The example panel clips 130 extend from a body portion 134 of the service panel 126. When the service panel 126 is held relative to the cover 68 of the enclosure 60, the body portion 134 of the service panel 126 spans the service opening 120. Generally, the panel clips 130 extend from a base portion 142 adjacent the body portion 134 to a tip portion 146. The panel clips 130 each include an overhang surface 150 located between the base portion 142 and the tip portion 146. The overhang surface 150 faces generally back toward the body portion 134. The panel clips 130 further include a ramped surface 154 extending from the tip portion 146 to the overhang surface 150. The panel clips 130 have a half-arrowhead profile, but other profiles could be used.

As can be appreciated, when the service panel 126 is initially moved in a direction D toward the clipped position of FIG. 7 to cover the service opening 120, a corner area 156 of the cover 68 contacts and rubs along the ramped surface 154. This contact forces the panel clip 130 to flex in a direction F to permit the overhang surface 150 and tip portion 146 to move through the service opening 120.

After the corner area 156 slides along the ramped surface 154, and then continues past the overhang surface 150, the panel clip 130 flexes back in a direction opposite the direction F from a more flexed position to a less flexed position. After this movement, a portion P of the cover 68 is captured between the overhang surface 150 and the body portion 134 as shown in FIG. 7.

The panel clips 130 are integrally formed with the body portion 134 of the service panel 126. Integrally forming the panel clips 130 with the body portion 134 can reduce, or eliminate, the need for separate mechanical fasteners and other more complex fastening mechanisms required to secure the service panel 126 to the cover 68. Using the panel clips 130, the enclosure clips 132, or both rather than mechanical fasteners can also reduce part count and reduce service time.

In this example, the enclosure clips 132 have a similar configuration to the panel clips 130. That is, the enclosure clips 132 extend from a base portion 158 that interfaces with an outwardly facing surface 162 of the cover 68 to a tip portion 166. The enclosure clips 132 additionally each include an overhang surface 170 and a ramped surface 174 to provide the enclosure clips 132 with a half arrow profile as shown in FIG. 7.

When the service panel 126 moves in the direction D into the clipped position with the cover 68, a corner area 175 of the body portion 134 contacts and rubs along the ramped surface 174 to flex the enclosure clips 132 outward away from the service opening 120.

After moving the body portion 134 into contact with the outwardly facing surface 162 of the cover 68, the enclosure clips 132 are free to flex back toward the service opening 120 to capture an outer peripheral portion of the body portion 134 between the overhang surface 170 and the outwardly facing surface 162 of the cover 68.

The enclosure clips 132 are integrally formed with the cover 68 of the enclosure. The example enclosure clips 132 are thus incorporated into the enclosure 60 when the service lid 112 is still attached to the remaining portions of the cover 68 even though the enclosure clips 132 are not used to secure the service lid 112.

In this example, an outer periphery of the body portion 134 of the service panel 126 provides a groove 176 that receives a compressible seal 178. When the service panel 126 is clipped to the cover 68, the compressible seal 178 is compressed within the groove 176 against the outwardly facing surface 162. The compressible seal 178 seals an interface between the service panel 126 and the cover 68 to prevent contaminants from entering the interior 70 through the interface when the service panel 126 is in the clipped position of FIG. 7. The compressible seal 178 is considered a gasket or 0-ring in some examples. In another example the sealing gasket may be composed of a curing liquid material such as a silicone material.

Although some embodiments can omit the compressible seal 178 or another separate sealing feature, sealing the interface can be particularly required when the service lid 112 is removed from the cover 68 using the tear strip 116, which may lead to roughness about the service opening 120. The roughness could inhibit the service panel 126 from sealing tightly against the cover 68 without the compressible seal 178 or another type of sealing feature.

FIGS. 2 to 7, and the remaining embodiments of this disclosure, illustrate examples of the service panel 126 that can be incorporated into the enclosure 60 of the traction battery pack 14. The service panel 126, and the remaining exemplary service panels, are not necessarily shown to the scale that would be used in practice and some features may be enlarged to better illustrate their design and operability.

In this disclosure, like reference numbers designate like elements where appropriate and reference numerals with the addition of a lowercase alphabetic character designate modified elements that are understood to generally incorporate the same features and benefits of the corresponding original elements.

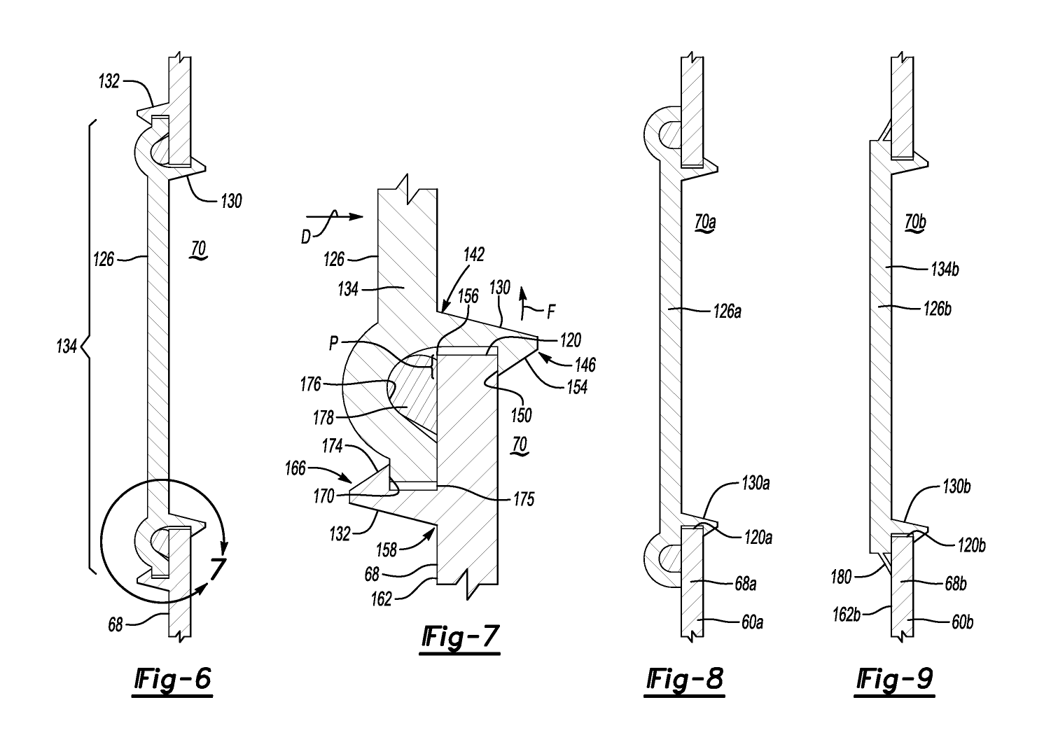

Referring now to FIG. 8 with reference to FIG. 6, another example service panel 126a is held relative to a cover 68a by panel clips 130a and without using the enclosure clips 132. The panel clips 130a have a similar configuration to the panel clips 130b of FIG. 6. The service panel 130a covers a service opening 120a to an interior 70a of an enclosure 60a.

In yet another exemplary embodiment, the service panel 126 of the FIG. 6 is held relative to the cover 68 with the enclosure clips 132 and without using the panel clips 130a.

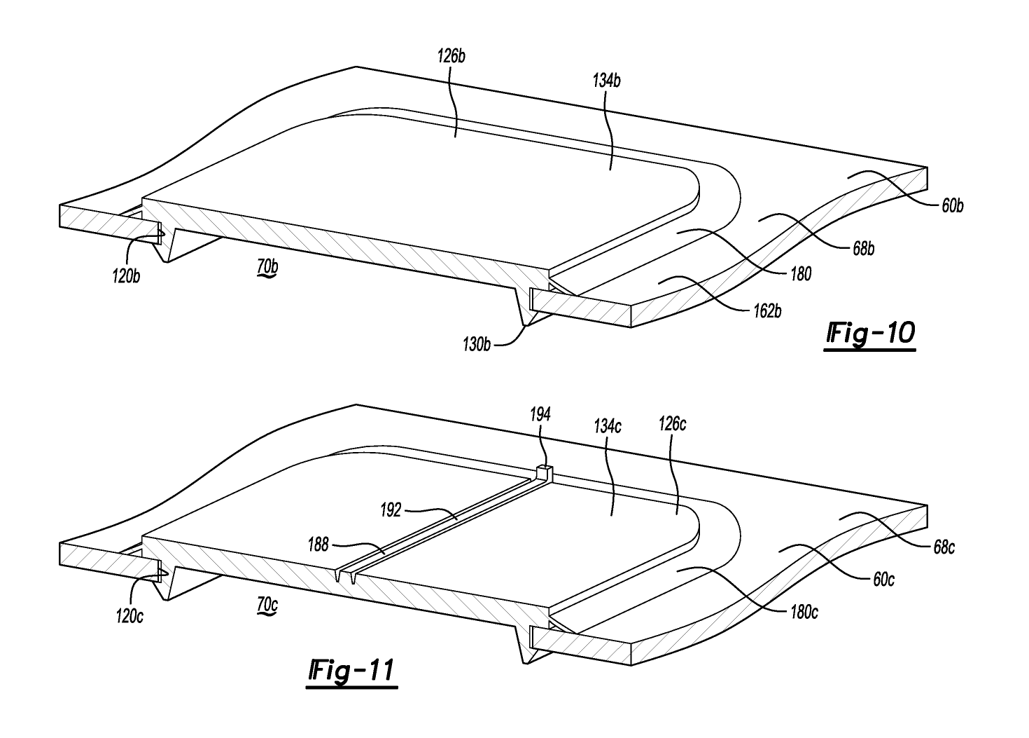

Referring now to FIGS. 9 and 10, another example service panel 126b is held relative to the cover 68b in a position covering a service opening 120b to the interior 70b using panel clips 130b and without the enclosure clips 132 of FIG. 6. The panel clips 130b are configured similarly to the panel clips 130b of FIG. 6 in this example. The service panel 130b covers the service opening 120b to an interior 70b of an enclosure 60b.

The service panel 126b additionally includes a flange 180 circumscribing a perimeter of a body portion 134b of the service panel 126b. The flange 180 effectively takes the place of the compressible seal 178 in the service panel 126 of FIG. 6.

When the service panel 126b is held in a clipped position relative to the cover 68b, and is covering the service opening 120b to the interior 70b, the flange 180 is biased against an outwardly facing surface 162b of the cover 68b. The flange 180, and the biasing of the flange 180 against the outwardly facing surface 162b can block contaminants from entering an interface between the service panel 126b and the cover 68b.

In another example, the service panel 126b could provide the flange 180 about a portion of its perimeter, say two sides, and the compressible seal 178 about another portion of its perimeter, say two other sides. In such an example, the flange 180 blocks contaminants from entering some areas of the interface between the service panel 126b and the cover 68b, and the compressible seal blocks contaminants through other areas. In yet another example, the flange 180 and the compressible seal 178 could both circumscribe a perimeter of a body portion 134b of the service panel 126b to provide a two stage seal.

Referring now to FIG. 11, another example service panel 126c is configured similarly to the service panel 126b of FIGS. 9 and 10, except the service panel 126c includes a ductile portion 188 integrally formed with a body portion 134c of the service panel 126c. The ductile portion 188 comprises a tear strip 192 and a pull tab 194.

The service panel 126c in the clipped position covers a service opening 120c to an interior 70c of an enclosure 60c having the cover 68c. If access to the interior 70c is required after the service panel 126c has been clipped to the cover 68c, the pull tab 194 can be pulled to separate the tear strip 192 from the remaining portions of the service panel 126c. The service panel 126c is then separated into multiple pieces and can be removed from the cover 68c to permit access to the interior 70c through the service opening 120c.

Notably, the ductile portion 188 can be incorporated into any of the service panel embodiments of this disclosure. That is, the ductile portion 188 is not limited to the embodiment of FIG. 11, which includes a flange 180c and no enclosure clips 132. The ductile portion 188 could instead be used in connection with, for example, the embodiment of FIG. 6.

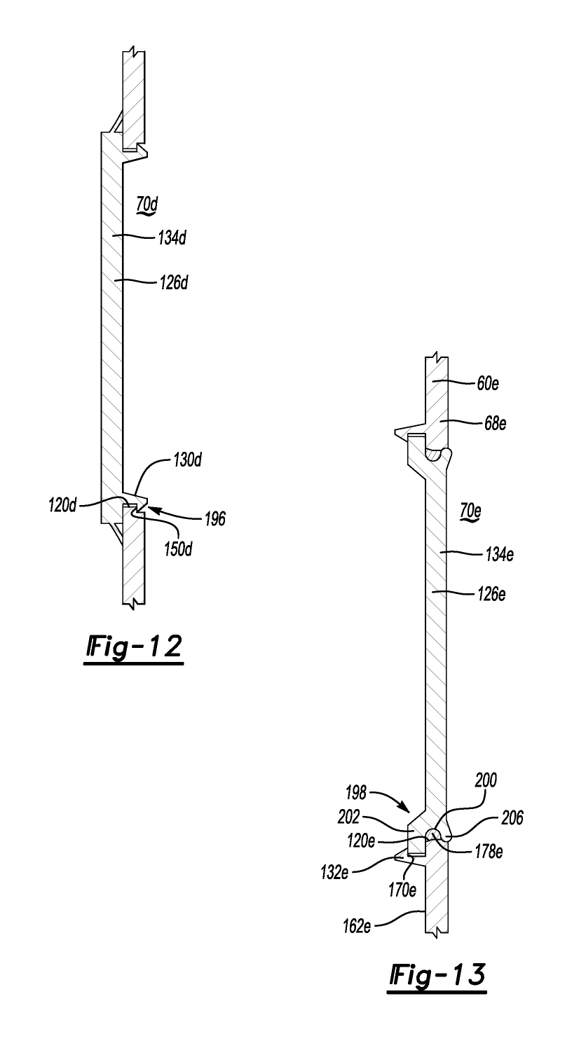

Referring now to FIG. 12, another service panel 126d is configured similarly to the service panel of FIGS. 9 and 10. That is, the service panel 126d includes panel clips 130d integrally formed with the remaining portions of the service panel 126d and including an overhang surface 150d.

The cover 68d differs from the cover 68b as the cover 68d includes a step 196 about a perimeter of the service opening 120d. The step 196 is thinned relative to other areas of the cover 68d. When the service panel 126d is clipped to the cover 68d, the overhang surface 150d contacts the step 196. That is, the entire thickness of the cover 68d is not held between the overhang surface 150d and a body portion 134d of the service panel 126d.

Since the thinned area of the step 196 is held between the overhang surface 150d and the body portion 134d, the panel clips 130d do not protrude into the interior 70d as far as the panel clips 130-130c of the embodiments of FIGS. 6 to 11. The service panel 126d thus provides more clearance for components within the interior 70d than the service panels 126-126c.

In this example, the panel clips 130d used in connection with the step 196 are about half the length of the panel clips 130 used in connection with the cover 68 lacking the step. Reducing the length of the panel clips 130d by about half from the clips 130, without changing a thickness or material, can decrease the potential deflection or flexibility of the clips 130d in the direction F by a factor of four. The number of clips 130d required to retain the service panel 126d can be adjusted to provide adequate retention of the service panel 126d.

Notably, the step 196 can be used in connection with any of the embodiments of this disclosure that use panel clips 130-130d and where additional clearance is desired.

Referring now to FIG. 13, yet another example service panel 126e incorporates a claw 198 extending circumferentially about a body portion 134e of the service panel 126e. Notably, the service panel 126e does not include panel clips 130 like the service panel 126 of FIGS. 6 and 7. The service panel 126 is clipped to a cover 68e to cover an opening 120e to an interior 70e of an enclosure 60e having the cover 68e.

A compressible seal 178e is held within a recessed area 200 of the claw 198. The recessed area 200 is provided between a first jaw 202 and a second jaw 206 of the claw 198.

When the service panel 126e is clipped to the cover 68e, the first jaw 202 of the claw 198 is captured between an overhang surface 170e of an enclosure clip 132e extending from an outwardly facing surface 162e of a cover 68e. The second jaw 206 the claw 198 extends at least partially into the interior 70e. The recessed area 200 presses the compressible seal 178 against the cover to seal an interface between the service panel 126e and the cover 68e.

Features of the disclosed examples include a service panel that can be used to cover a service opening of an enclosure. In some examples, the service panel covers a service opening established by removing an integrally formed lid in the enclosure when servicing components within an interior of the enclosure. The service panel, in such examples, can be considered an after-market component. Features utilized to hold the service panel relative to the enclosure are, in some examples, integrally formed with the service panel, the enclosure, or both, which can reduce the need for separate mechanical fasteners.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery assembly, comprising:
an enclosure defining an interior; and
a service panel that covers an opening to the interior, the service panel held relative to the enclosure by at least one clip.

2. The battery assembly of claim 1, wherein the service panel and the enclosure are both polymer based.

3. The battery assembly of claim 1, wherein the at least one clip is integrally formed with the service panel.

4. The battery assembly of claim 1, wherein the at least one clip includes an overhang surface that contacts a surface of the enclosure facing toward the interior to hold a portion of the enclosure between a body of the service panel and the overhang surface.

5. The battery assembly of claim 4, wherein the surface is provided a stepped area in a wall of the enclosure that is thinned relative to other areas of the wall.

6. The battery assembly of claim 1, wherein the at least one clip is integrally formed with the enclosure and include an overhang surface that contacts a surface of the service panel facing away from the interior to hold a portion of the service panel between enclosure and the overhang surface.

7. The battery assembly of claim 1, wherein the at least one clip is configured to move from a more flexed position to a less flexed position to hold the service panel relative to the enclosure.

8. The battery assembly of claim 1, wherein the at least one clip includes at least one panel clip integrally formed with the service panel and at least one enclosure clip integrally formed with the enclosure, the at least one panel clip providing an overhang surface that contacts a surface of the enclosure facing toward the interior to hold a portion of the enclosure between a portion of the service panel and the overhang surface, the at least one enclosure clip providing another overhang surface that contacts a surface of the service panel facing away from the interior to hold a portion of the service panel between enclosure and the overhang surface.

9. The battery assembly of claim 1, further comprising a flange of the service panel, the flange biased against an outwardly facing surface of the enclosure when the service panel is held relative to the enclosure such that the flange seals an interface between the service panel and the enclosure.

10. The battery assembly of claim 9, wherein the flange circumscribes a perimeter of a body of the service panel.

11. The battery assembly of claim 1, further comprising a compressible seal member that seals an interface between the service panel and the enclosure.

12. The battery assembly of claim 1, further comprising a ductile portion of the service panel that is removable to access the at least one clip.

13. The battery assembly of claim 1, wherein the opening is a service opening, and the interior accommodates at least one serviceable part.

14. The battery assembly of claim 1, wherein the enclosure and the service panel are portions of a traction battery pack of an electrified vehicle.

15. A method, comprising:
covering an opening in an enclosure with a service panel that is clipped to the enclosure, the opening permitting access to at least one serviceable part housed inside of the enclosure assembly prior to the covering.

16. The method of claim 15, wherein at least one clip that clips the service panel to the opening is integrally formed with the service panel or the enclosure.

17. The method of claim 15, further comprising compressing a seal member between the service panel and the enclosure to seal an interface between the service panel and the enclosure.

18. The method of claim 15, further comprising biasing a flange of the service panel against an outwardly facing surface of the enclosure to seal an interface between the service panel and the enclosure.

19. The method of claim 18, wherein the flange flexes during the biasing.

20. The method of claim 15, further comprising, prior to the covering, establishing the opening in the enclosure by removing a cover that is integrally formed with the enclosure.
